(19) United States
(12) Patent Application Publication
(10) Pub. No.: US 2018/0264846 A1
(43) Pub. Date: Sep. 20, 2018

(54) Method of Reproducing a Cellular Phone Snapshot on a Shirt at Remote Locations

(71) Applicant: JASON MCCOY, Miami, FL (US)

(72) Inventor: JASON MCCOY, Miami, FL (US)

(21) Appl. No.: 15/458,441

(22) Filed: Mar. 14, 2017

(51) Int. Cl. B41J 3/407

(52) U.S. Cl. CPC B41J 3/4078

(57) ABSTRACT

A method of reproducing a cellular phone snapshot on a shirt at a remote location. The method comprises providing a mobile vehicle, installing a t-shirt printing machine in the vehicle, wherein the t-shirt printing machine can operatively connect to a cellular phone device and accept a digital transmission, providing an operator of the t-shirt printing machine that interacts with the public at remote locations to offer and solicit the service of printing snapshots from their cellular phone devices on t-shirts, receiving the snapshots solicited on the t-shirt printing machine, printing the t-shirts on the t-shirt printing machines at the remote locations, and delivering the t-shirts to the public at the remote locations. The method may further comprise accepting payment for the t-shirts upon the t-shirts being accepted by the public solicited.

### BACKGROUND

The present invention is directed to a method of reproducing a cellular phone snapshot on a shirt at remote locations.

The inventor of the present invention conceived a method of reproducing a cellular phone snapshot on a shirt at remote locations.

He realized that many great photographs are taken on vacations, beaches and events that are never reproduced after the initial shot.

So he decided that a more lasting memory of an event for the taker of the snapshot would be to allow the taker to reproduce his or her snapshot on a shirt at a remote location in a manner that would not cause the taker to disrupt his vacation, beach outing or event.

He figured that by having a mobile vehicle that is equipped with a device that can print or reproduce a digital image on a shirt while the owner of the snapshot was within the vicinity would allow the owner to wear his memory on the shirt while enjoying the surrounding of where the snapshot was taken.

The inventor also realized that the present method would create an industry that would create jobs at remote locations by providing the public with a means of efficiently reproducing their intimate images or memories on shirts that they could immediately wear after their reproduction on the shirts.

For the foregoing reasons there is a need for a method of reproducing a cellular phone snapshot on a shirt at remote locations that will create jobs and that will allow users of the shirts to simultaneously wear their memories of their vacations, beach outings or events.

### SUMMARY

The present invention describes a method of reproducing a cellular phone snapshot on a shirt at remote locations that creates jobs and that allows users of the shirts to simultaneously wear their memories of their vacations, beach outings or events.

The method comprises providing a mobile vehicle, installing a t-shirt printing machine in the vehicle, wherein the t-shirt printing machine can operatively connect to a cellular phone device and accept a digital transmission, providing an operator of the t-shirt printing machine that interacts with the public at remote locations to offer and solicit the service of printing snapshots from their cellular phone devices on t-shirts to remember, receiving the snapshots solicited on the t-shirt printing machine, printing the t-shirts on the t-shirt printing machines at the remote locations, and delivering the t-shirts to the public at the remote locations.

The method may further comprise accepting payment for the t-shirts upon the t-shirts being accepted by the public solicited.

An object of the present invention is to provide a method of reproducing a cellular phone snapshot on a shirt at remote locations that will create jobs.

Another object of the present invention is to provide a method of reproducing a cellular phone snapshot on a shirt at remote locations that will allow users of the shirts to simultaneously wear their memories of their vacations, beach outings or events.

### DRAWINGS

These and other features, aspects, and advantages of the present invention will become better understood with regard to the following description, appended claims, and drawings where:

FIG. 1 is a flow chart that described the method of the present invention.

### DESCRIPTION

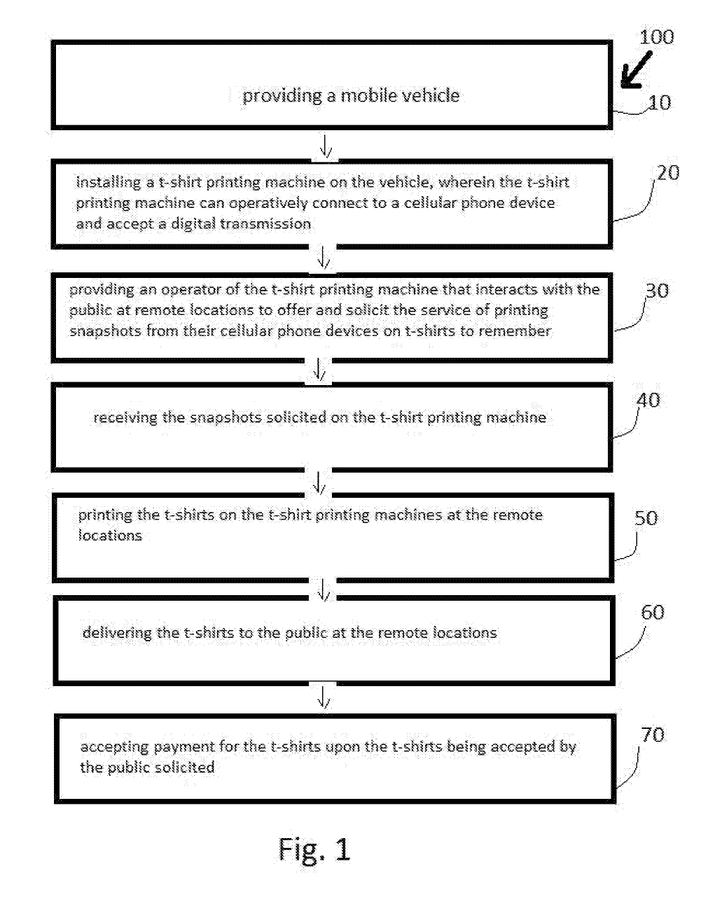

As seen in FIG. 1, the present invention is a method of reproducing a cellular phone snapshot on a shirt at a remote location 100. The method comprises providing a mobile vehicle 10, installing a t-shirt printing machine 20 on the vehicle 10, wherein the t-shirt printing machine can operatively connect to a cellular phone device and accept a digital transmission, providing an operator 30 of the t-shirt printing machine that interacts with the public at remote locations to offer and solicit the service of printing snapshots from their cellular phone devices on t-shirts to remember, receiving the snapshots 40 solicited on the t-shirt printing machine, printing the t-shirts 50 on the t-shirt printing machines at the remote locations, and delivering the t-shirts 60 to the public at the remote locations.

The method may further comprise accepting payment 70 for the t-shirts 60 upon the t-shirts being accepted by the public solicited.

In an embodiment of the present invention, the operator is a robotic device that is programmed to work an area and that can interact with the public upon the public's solicitation.

An advantage of the present invention is that it provides a method of reproducing a cellular phone snapshot on a shirt at remote locations that creates jobs.

Another advantage of the present invention is that it provides a method of reproducing a cellular phone snapshot on a shirt at remote locations that allows users of the shirts to simultaneously wear their memories of their vacations, beach outings or events.

While the inventor's above description contains many specificities, these should not be construed as limitations on the scope, but rather as an exemplification of several preferred embodiments thereof. Many other variations are possible. For example, the present invention can be described to switch the placement of the apron body, the holsters and the pocket so that the apron could be worn either on the left or the right side of the therapist. Accordingly, the scope should be determined not by the embodiments illustrated, but by the appended claims and their legal equivalents.

What is claimed is:

1. A method of reproducing a cellular phone snapshot on a shirt at a remote location, the method comprising:
providing a mobile vehicle;
installing a t-shirt printing machine in the vehicle, wherein the t-shirt printing machine can operatively connect to a cellular phone device and accept a digital transmission;
providing an operator of the t-shirt printing machine that interacts with the public at remote locations to offer and solicit the service of printing snapshots from their cellular phone devices on t-shirts;
receiving the snapshots solicited on the t-shirt printing machine;
printing the t-shirts on the t-shirt printing machines at the remote locations; and
delivering the t-shirts to the public at the remote locations.

2. The method of claim 1, comprising accepting payment for the t-shirts upon the t-shirts being accepted by the public solicited.

3. The method of claim 2, wherein the operator is a robotic device that is programmed to work an area and that can interact with the public upon the public's solicitation.
